(19) United States
(12) Patent Application Publication
(10) Pub. No.: US 2025/0334396 A1
(43) Pub. Date: Oct. 30, 2025

(54) LIGHT IRRADIATION DEVICE, MEASUREMENT DEVICE, OBSERVATION DEVICE, AND FILM THICKNESS MEASUREMENT DEVICE

(71) Applicant: HAMAMATSU PHOTONICS K.K., Hamamatsu-shi, Shizuoka (JP)

(72) Inventors: Tomonori NAKAMURA, Hamamatsu-shi, Shizuoka (JP); Satoshi TAKIMOTO, Hamamatsu-shi, Shizuoka (JP)

(73) Assignee: HAMAMATSU PHOTONICS K.K., Hamamatsu-shi, Shizuoka (JP)

(21) Appl. No.: 18/879,964

(22) PCT Filed: May 8, 2023
(86) PCT No.: PCT/JP2023/017308

§ 371 Date: Dec. 30, 2024

(30) Foreign Application Priority Data
Aug. 31, 2022 (JP) 2022-138163

(51) Int. Cl. G01B 11/06

(52) U.S. Cl. CPC G01B 11/0616

(57) ABSTRACT

A light irradiation apparatus includes a light source configured to emit light, a light pipe configured to receive, as an input, the light emitted from the light source, and uniformize and output an illuminance distribution of the light, a diffusion unit configured to diffuse the light output from the light pipe, and a light pipe configured to receive, as an input, the light diffused by the diffusion unit, and uniformize and output an illuminance distribution of the light. The diffusion unit is a light diffusion surface provided on a light output surface of the light pipe.

### TECHNICAL FIELD

One aspect of the present invention relates to a light irradiation apparatus, a measurement apparatus, an observation apparatus, and a film thickness measurement apparatus.

### BACKGROUND ART

Patent Literature 1 describes that a lighting apparatus includes diffusion plates on an input side and an output side of a light pipe to generate uniform light while reducing an irradiation density. Patent Literature 2 describes that a fundus observation apparatus includes a diffusion plate on an output side of a light pipe to generate a pseudo point light source and reduce illumination spots.

### CITATION LIST

### Patent Literature

Patent Literature 1: Japanese Unexamined Patent Publication No. 2017-134992
Patent Literature 2: Domestic Re-publication of PCT International Patent Application No. WO2019/240300

### SUMMARY OF INVENTION

### Technical Problem

Here, in a configuration in which a diffusion plate is disposed on an output side of a light pipe such as a light pipe as in the configurations of Patent Literatures 1 and 2 described above, since a target at a subsequent stage is irradiated with light diffused by the diffusion plate, an image of irregularities of the diffusion plate may be formed on a light image of the target. That is, in the configuration described above, the light with which the target is irradiated cannot be sufficiently uniformized.

One aspect of the present invention has been made in view of the above circumstances, and an object thereof is to provide a light irradiation apparatus, a measurement apparatus, an observation apparatus, and a film thickness measurement apparatus capable of appropriately uniformizing light with which a target is irradiated.

### Solution to Problem

### [E1]

A light irradiation apparatus according to one aspect of the present invention includes a light source configured to emit light, a first light pipe configured to receive, as an input, the light emitted from the light source, and uniformize and output an illuminance distribution of the light, a diffusion unit configured to diffuse the light output from the first light pipe, and a second light pipe configured to receive, as an input, the light diffused by the diffusion unit, and uniformize and output an illuminance distribution of the light. The diffusion unit is a light diffusion surface provided on at least one of a light output surface of the first light pipe and a light input surface of the second light pipe.

In the light irradiation apparatus according to one aspect of the present invention, the illuminance distribution of the light emitted from the light source is uniformized by the first light pipe, the light output by the first light pipe is diffused by the diffusion unit, and the illuminance distribution of the light diffused by the diffusion unit is uniformized by the second light pipe. The first light pipe is provided, and thus, the diffusion unit is irradiated with the uniformized light. In addition, the diffusion unit is provided, and thus, a virtual image of non-uniform light incident on the first light pipe (that is, a virtual image on the light source side) is prevented from being incident on the second light pipe at the subsequent stage. Further, the second light pipe is provided, and thus, the diffused light from the diffusion unit is uniformized. As a result, an image of irregularities of the diffusion unit is prevented from being formed on the light image of the target to be finally irradiated with light. From the above, in accordance with the light irradiation apparatus of one aspect of the present invention, the light with which the target is irradiated can be appropriately uniformized.

Here, in the light irradiation apparatus according to one aspect of the present invention, the diffusion unit is the light diffusion surface provided on at least one of the light output surface of the first light pipe and the light input surface of the second light pipe. In accordance with such a configuration in which the light diffusion surface is provided on the light output surface (or the light input surface) of the light pipe, for example, since a loss of light corresponding to a thickness of the diffusion plate, which is a problem in a configuration in which the diffusion plate or the like is sandwiched as a separate member between two light pipes, is suppressed, a decrease in intensity of light can be appropriately suppressed.

### [E2]

In the light irradiation apparatus according to the above [E1], a diameter of the light input surface of the second light pipe may be the same as a diameter of the light output surface of the first light pipe. For example, in a case where the diameter of the light output surface of the first light pipe is smaller than the diameter of the light input surface of the second light pipe, since the light is input only to a part of the light input surface of the second light pipe, there is a possibility that the light output from the second light pipe is not sufficiently uniformized. Since the diameter of the light input surface of the second light pipe is the same as the diameter of the light output surface of the first light pipe, it is possible to achieve uniformity of light output from the second light pipe and suppression of a decrease in the amount of light.

### [E3]

In addition, in the light irradiation apparatus according to the above [E1], a diameter of the light input surface of the second light pipe may be smaller than a diameter of the light output surface of the first light pipe. For example, in a case where the diameter of the light output surface of the first light pipe is smaller than the diameter of the light input surface of the second light pipe, since the light is input only to a part of the light input surface of the second light pipe, there is a possibility that the light output from the second light pipe is not sufficiently uniformized. The diameter of the light input surface of the second light pipe is smaller than the diameter of the light output surface of the first light pipe, and thus, the light output from the second light pipe can be uniformized.

### [E4]

In the light irradiation apparatus according to the above [E1] to [E3], a diameter of a light output surface of the second light pipe may be larger than a diameter of the light input surface of the second light pipe. As described above, the second light pipe is formed in a tapered shape whose diameter increases toward the light output surface, the irradiation range on the sample can be expanded, and a wide range can be irradiated with uniform light.

### [E5]

In addition, in the light irradiation apparatus according to the above [E1] to [E4], the light diffusion surface may be a translucent surface. In this case, the diffusion unit can be easily formed by making at least one of the light output surface of the first light pipe and the light input surface of the second light pipe translucent.

### [E6]

A measurement apparatus according to one aspect of the present invention includes the light irradiation apparatus according to any one of the above [E1] to [E5], and an imaging unit configured to image measurement light generated by light with which a measurement target is irradiated from the light irradiation apparatus. In accordance with such a configuration, the measurement target can be irradiated with the uniformized light, and the measurement light generated by the measurement target can be imaged with high accuracy.

### [E7]

An observation apparatus according to one aspect of the present invention includes the light irradiation apparatus according to any one of the above [E1] to [E5], and an imaging unit configured to image observation light that is light with which a measurement target is irradiated from the light irradiation apparatus. In accordance with such a configuration, the measurement target can be irradiated with the uniformized light, and the observation light can be imaged with high accuracy.

### [E8]

A film thickness measurement apparatus according to one aspect of the present invention includes the light irradiation apparatus according to any one of the above [E1] to [E5], an imaging unit configured to image observation light that is light with which a measurement target is irradiated from the light irradiation apparatus, and output imaging data, and a film thickness derivation unit configured to derive a film thickness of the measurement target based on the imaging data. In accordance with such a configuration, the measurement target can be irradiated with the uniformized light, and the film thickness of the measurement target can be derived with high accuracy.

### Advantageous Effects of Invention

In accordance with one aspect of the present invention, it is possible to provide the light irradiation apparatus, the measurement apparatus, the observation apparatus, and the film thickness measurement apparatus capable of appropriately uniformizing the light with which the target is irradiated.

### BRIEF DESCRIPTION OF DRAWINGS

FIG. 1 is a configuration diagram of a measurement apparatus including a light irradiation apparatus according to the present embodiment.

FIG. 2 is a detailed configuration diagram of a light pipe illustrated in FIG. 1.

FIG. 3 is a configuration diagram of a measurement apparatus according to a first comparative example.

FIG. 4 is a configuration diagram of a measurement apparatus according to a second comparative example.

FIG. 5(a) is a diagram illustrating an imaging result of the measurement apparatus according to the first comparative example, FIG. 5(b) is a diagram illustrating an imaging result of the measurement apparatus according to the second comparative example, and FIG. 5(c) is a diagram illustrating an imaging result of the measurement apparatus according to the present embodiment.

FIG. 6 is a configuration diagram of a light pipe according to a modification.

FIG. 7 is a configuration diagram of an observation apparatus including a light irradiation apparatus according to a modification.

FIG. 8 is a configuration diagram of a film thickness measurement apparatus including a light irradiation apparatus according to a modification.

### DESCRIPTION OF EMBODIMENTS

Hereinafter, an embodiment of the present invention will be described in detail with reference to the drawings. Note that, in the drawings, the same or corresponding parts are denoted by the same reference signs, and redundant description will be omitted.

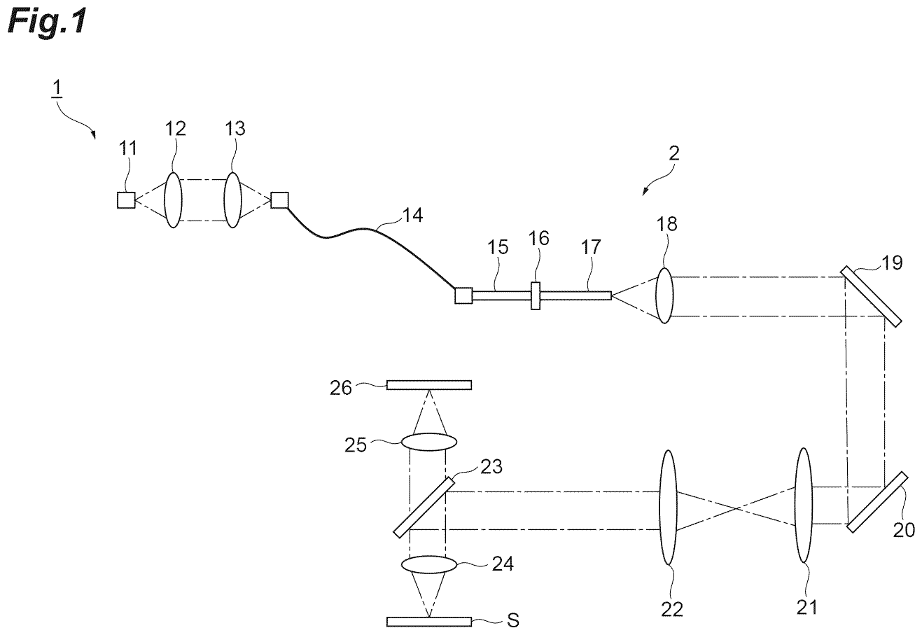

FIG. 1 is a configuration diagram of a measurement apparatus 1 including a light irradiation apparatus 2 according to the present embodiment. The measurement apparatus 1 is an inspection apparatus that inspects a sample S (measurement target). The sample S is, for example, a semiconductor device in which a plurality of light emitting elements are formed on a substrate. In addition, the sample S may be a substrate or an epitaxial layer before various devices are formed. The light emitting element is, for example, an LED, a mini LED, a μLED, an SLD element, a laser element, a vertical laser element (VCSEL), or the like. For example, the measurement apparatus 1 irradiates a predetermined range on the sample S with excitation light having uniform intensity, images photoluminescence (specifically, emission light such as fluorescence) generated in the predetermined range, and inspects the sample S based on obtained image data.

For example, the measurement apparatus 1 may perform quality determination of each light emitting element by observing photoluminescence (specifically, emission light such as fluorescence) of the plurality of light emitting elements formed in the sample S. It is conceivable that the quality determination of the light emitting element is performed by, for example, probing (that is, based on electrical characteristics). However, it is physically difficult to perform probing in which a needle is brought into contact with a fine LED such as a μLED to perform measurement. In this regard, in the quality determination method of the light emitting element based on the photoluminescence, since the quality determination can be performed by acquiring a fluorescence image, it is possible to efficiently perform quality determination of a large number of light emitting elements without being influenced by physical restrictions.

As illustrated in FIG. 1, the measurement apparatus 1 includes the light irradiation apparatus 2 and an imaging unit 26. The light irradiation apparatus 2 is an apparatus that irradiates the sample S with uniform light and uniformly excites the sample S. The light irradiation apparatus 2 includes a light source 11, light guide lenses 12 and 13, an optical fiber cable 14, light pipes 15 and 17 (first uniformizing optical system and second uniformizing optical system), a diffusion unit 16, a light guide lens 18, mirrors 19 and 20, light guide lenses 21 and 22, a half mirror 23, an objective lens 24, and an image forming lens 25. In addition, the sample S is held by, for example, a chuck (not illustrated) that vacuum-adsorbs the sample S on the substrate. In this case, the chuck (not illustrated) may be moved by an XY stage (not illustrated) that moves the chuck in XY directions (front-back and left-right directions).

The light source 11 generates excitation light with which the sample S is irradiated and emits the excitation light toward the sample S. The light source 11 may be, for example, a white light source capable of generating light including a wavelength that excites the light emitting element of the sample S. The white light source is, for example, an LED, a laser, a halogen lamp, a mercury lamp, a D2 lamp, a plasma light source, or the like.

The light guide lens 12 guides the excitation light emitted from the light source 11 toward the light guide lens 13. The light guide lens 13 guides the excitation light having reached via the light guide lens 12 toward the optical fiber cable 14. The light guide lenses 12 and 13 are, for example, convex lenses.

The optical fiber cable 14 is an optical fiber cable for guiding light. The optical fiber cable 14 guides the excitation light having reached via the light guide lens 13 toward the light pipe 15. For example, a polarization preserving fiber, a single mode fiber, or the like can be used as the optical fiber cable 14.

The light pipe 15 is an optical system on which the excitation light (the light having reached via the optical fiber cable 14) emitted from the light source 11 is incident and which uniformizes and outputs an illuminance distribution of the excitation light. The light pipe 15 is an optical element that uniformly emits the incident light by reflecting the incident light multiple times on a side surface of a polygonal prism or a polygonal weight. A light diffusion surface 16a constituting the diffusion unit 16 is formed on a light output surface of the light pipe 15 (described later). The excitation light uniformized by the light pipe 15 is incident on the light diffusion surface 16a which is the diffusion unit 16.

A diameter and a length of a light input surface of the light pipe 15 depend on a spreading angle of light incident on the light input surface of the light pipe 15 (for example, NA of the optical fiber cable 14), a total reflection angle of the light pipe 15 (for example, NA of the light pipe 15), or the like. In addition, a diameter of a light output surface of the light pipe 15 depends on a size of a light irradiation range on the sample S and the like. Further, in a case where a diameter of the light pipe 15 is D and the smaller NA of the NA of the optical fiber cable 14 and the NA of the light pipe 15 is α, a length L of the light pipe 15 may be larger than D/α, for example, may be larger than D/α+1. Further, preferably, the length of the light pipe may be larger than 3D/α. As the length of the light pipe 15 is longer, a degree of uniformization of light can be improved.

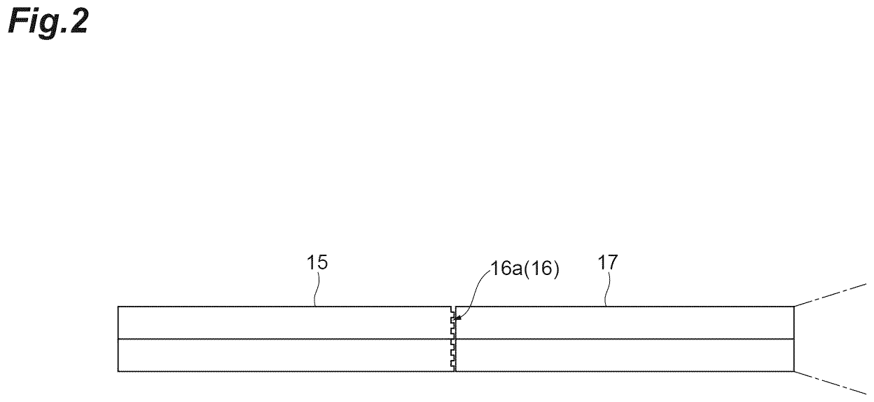

The diffusion unit 16 is a portion that diffuses the excitation light emitted from the light pipe 15. FIG. 2 is a detailed configuration diagram of the diffusion unit 16. The diffusion unit 16 is the light diffusion surface 16a formed on the light output surface of the light pipe 15. The light diffusion surface 16a is a part of the light pipe 15, and is formed by processing the light output surface of the light pipe 15. The light diffusion surface 16a is, for example, a translucent surface having irregularities formed on a front surface. The light diffusion surface 16a is, for example, a surface obtained by performing blasting on the light output surface of the light pipe 15 such that light can be diffused and forming the irregularities on the front surface. Various kinds of processing forms such as sand blasting, air blasting, and shot blasting can be considered as the blasting. In addition, the front surface of the light diffusion surface 16a may be corroded and formed smoothly by, for example, hydrogen fluoride. The light diffusion surface 16a may be formed on the entire light output surface of the light pipe 15 or may be formed only on a part thereof. The light diffusion surface 16a may diffuse light by an aspect other than the surface obtained by blasting as long as the aspect can diffuse light. The light diffusion surface 16a is formed, and thus, a virtual image of non-uniform light incident on the light pipe 15 (that is, a virtual image on the light source 11 side) is prevented from being incident on the light pipe 17 at a subsequent stage.

Note that, in the present embodiment, it has been described that the light diffusion surface 16a is formed on the light output surface of the light pipe 15, but the present invention is not limited thereto. The light diffusion surface 16a may be formed on a light input surface of the light pipe 17 at the subsequent stage. In addition, the light diffusion surface 16a may be formed on both the light output surface and the light input surface of the light pipe 15.

The light pipe 17 is an optical system on which the excitation light diffused by the diffusion unit 16 is incident and which uniformizes and outputs an illuminance distribution of the excitation light. The light pipe 17 is an optical element that uniformly emits the incident light by reflecting the incident light multiple times on a side surface of a polygonal prism or a polygonal weight. The light pipe 17 is provided, and thus, the diffused light from the diffusion unit 16 is uniformized. As a result, an image of irregularities of the diffusion unit 16 is prevented from being formed on a light image of the sample S to be finally irradiated with light.

Since the diffused light diffused by the diffusion unit 16 is input to the light input surface of the light pipe 17, a diameter and a length of the light input surface of the light pipe 17 depend on a total reflection angle of the light pipe 17 (for example, NA of the light pipe 17) and the like. In addition, a diameter of a light output surface of the light pipe 17 depends on the size of the light irradiation range on the sample S and the like. Further, in a case where a diameter of the light pipe 17 is D and the NA of the light pipe 17 is β, a length L of the light pipe 17 may be larger than D/β, for example, may be larger than D/β+1. Further, preferably, the length of the light pipe may be larger than 3D/β. As the length of the light pipe 17 is longer, a degree of uniformization of light can be improved.

The diameter of the light input surface of the light pipe 17 may be the same as the diameter of the light output surface of the light pipe 15. In addition, the diameter of the light input surface of the light pipe 17 may be smaller than the diameter of the light output surface of the light pipe 15. In this case, the diameter of the light input surface of the light pipe 17 is allowed in a range of 100% to 50% of the diameter of the light output surface of the light pipe 15.

In addition, the diameter of the output surface of the light pipe 17 is allowed under a condition that an irradiation range on the sample S on which the output surface is projected is larger than an effective visual field size of a camera observing the sample S. For example, in a case where it is considered that a pattern image of the sample S is acquired, the diameter may be slightly larger than a visual field size. On the other hand, in a case where it is considered that the sample S is excited, the irradiation range on the sample S needs to be sufficiently larger than the visual field size.

The light guide lens 18 guides the excitation light emitted from the light pipe 17 toward the mirror 19. The mirror 19 guides the excitation light having reached via the light guide lens 18 toward the mirror 20. The mirror 20 guides the excitation light having reached via the mirror 19 toward the light guide lens 21. The light guide lens 21 guides the excitation light having reached via the mirror 20 toward the light guide lens 22. The light guide lens 22 guides the excitation light having reached via the light guide lens 21 toward the half mirror 23. The light guide lenses 18, 21, and 22 are, for example, convex lenses.

The half mirror 23 is a dielectric half mirror that separates excitation light and emission light by reflecting light of a specific wavelength and transmitting light of other wavelengths. The half mirror 23 may be a dichroic mirror created by using an optical material such as a dielectric multilayer film. Specifically, the half mirror 23 is configured to reflect the excitation light toward the objective lens 24 and transmit photoluminescence (specifically, emission light of fluorescence) from the light emitting element of the sample S, which is light of a wavelength band different from the excitation light, toward the image forming lens 25.

The objective lens 24 is a configuration for observing the sample S, and condenses the excitation light guided by the half mirror 23 on the sample S.

The image forming lens 25 is a lens that forms an image of emission light from the sample S transmitted through the half mirror 23 and having reached, and guides the emission light to the imaging unit 26.

The imaging unit 26 is a camera that images the emission light from the sample S of which the image is formed by the image forming lens 25. That is, the imaging unit 26 is a camera that images emission light (measurement light) generated by the light with which the sample S is irradiated from the light irradiation apparatus 2. The imaging unit 26 is, for example, an area image sensor such as a CCD or a MOS. In addition, the imaging unit 26 may include a line sensor or a time delay integration (TDI) sensor.

In the measurement apparatus 1, the quality determination of each light emitting element of the sample S may be performed by an analysis unit (not illustrated) based on the emission light from the sample S imaged by the imaging unit 26. In addition, in the measurement apparatus 1, other inspection may be performed based on the emission light from the sample S imaged by the imaging unit 26.

Next, functions and effects of the light irradiation apparatus 2 and the measurement apparatus 1 including the light irradiation apparatus 2 according to the present embodiment will be described in comparison with comparative examples.

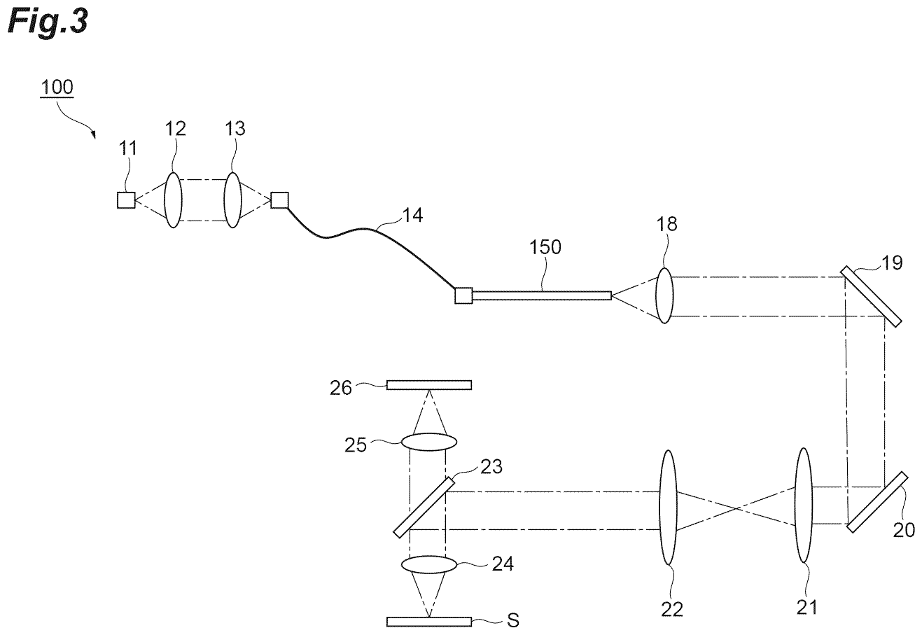

FIG. 3 is a configuration diagram of a measurement apparatus 100 according to a first comparative example. The measurement apparatus 100 has the same configuration as the measurement apparatus 1 except that one light pipe 150 (the light pipe having no light diffusion surface) is provided instead of the configuration including the two light pipes 15 and 17 and the diffusion unit 16 in the measurement apparatus 1.

In such a measurement apparatus 100, in a case where a light input surface side is viewed from a light output surface side of the light pipe 150, a large number of light sources are viewed to be present on the light input surface side due to total reflection on a side surface of the light pipe 150. The light input surface side are virtually illuminated from each direction by these multiple light sources, and thus, the light output surface of the light pipe 150 is uniformly illuminated regardless of anisotropy in light amounts of the light sources. The sample S is uniformly illuminated by optically relaying these light sources. Here, in a case where the relay optical system does not have any reflection surface and the sample S is a single surface, there is no problem in uniform illumination for the sample S.

However, in actual observation of the sample S, the sample S may be present on one surface (front surface) of a transparent substrate, and a reflection surface may be formed at a position away from the one surface (for example, a back surface of the sample S). In addition, there are a plurality of lenses inside the objective lens 24, and it is conceivable that a reflectance of a front surface of the lens does not become 0. In this case, a reflected image from the front surface of the sample S reflects the light output surface of the light pipe 150, but a reflected image from the other surface (the back surface of the sample S or the front surface of the lens of the objective lens 24) reflects a position shifted from the light output surface of the light pipe 150. Then, in a case where a reflecting position approaches the light input surface of the light pipe 150, non-uniformity of light incident on the light input surface appears on an imaged image as a virtual image. Such appearance of the virtual image is more noticeable in a case where the illumination itself is sufficiently uniform.

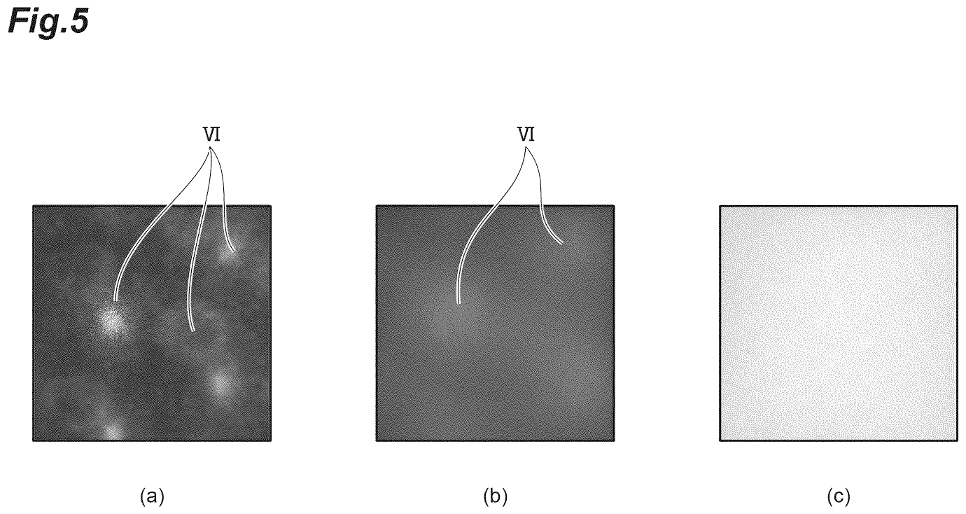

FIG. 5(a) is a diagram illustrating an imaging result of the measurement apparatus 100 according to the first comparative example. As illustrated in FIG. 5(a), a virtual image VI due to reflection from an unexpected reflection surface other than the front surface of the sample S appears on the imaged image imaged by the imaging unit 26. Such appearance of the virtual image VI is difficult to avoid only by using the light pipe 150 as long as the reflection surface other than the front surface of the sample S is present.

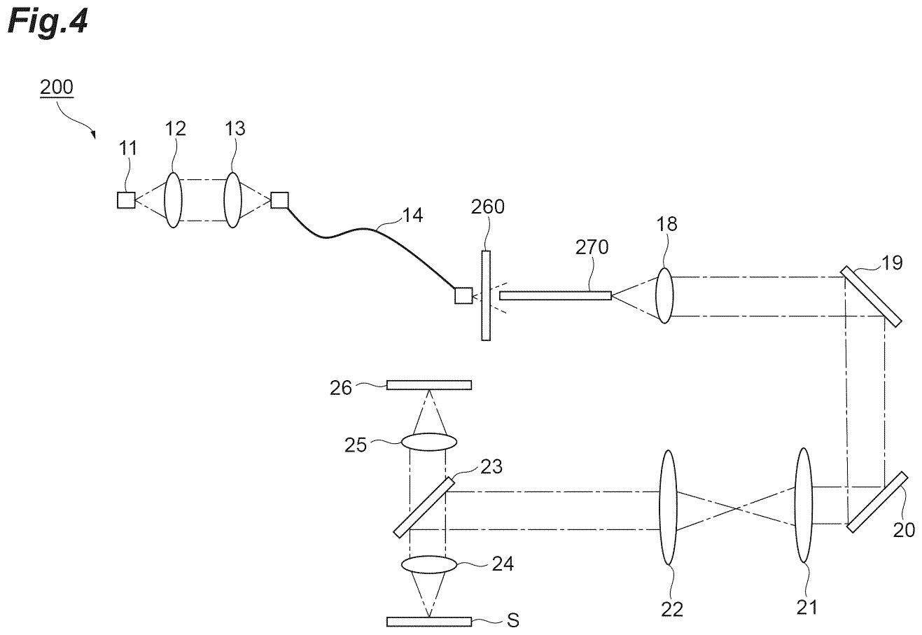

FIG. 4 is a configuration diagram of a measurement apparatus 200 according to a second comparative example. The measurement apparatus 200 has the same configuration as the measurement apparatus 1 except that one light pipe 270 and a diffusion plate 260 provided on a light input surface side of the light pipe 270 are provided instead of the configuration including the two light pipes 15 and 17 and the diffusion unit 16 in the measurement apparatus 1. In the measurement apparatus 200, the diffusion plate 260 that diffuses light to the light input surface side of the light pipe 270 in addition to the configuration of the measurement apparatus 100 illustrated in FIG. 3. The diffusion plate 260 is provided on the light input surface side as described above, and thus, the appearance of the virtual image described above is suppressed. However, incident light on the diffusion plate 260 is non-uniform by a fiber light source or the like, the non-uniformity remains, and the excitation light cannot be sufficiently uniformized.

FIG. 5(b) is a diagram illustrating an imaging result of the measurement apparatus 200 according to the second comparative example. As illustrated in FIG. 5(b), on the imaged image imaged by the imaging unit 26, the appearance of the virtual image VI is suppressed as compared with the imaged image imaged by the measurement apparatus 100 illustrated in FIG. 5(a). However, on the imaged image illustrated in FIG. 5(b), the appearance of the virtual image VI is not completely suppressed, and the non-uniformity of the light remains.

In addition, as another configuration, for example, a configuration in which the diffusion plate is provided on the light output surface side of one light pipe is conceivable. However, in such a configuration, the incident light on the diffusion plate is uniformized, but there is a problem that an image of a rough surface pattern (irregularities) of the diffusion plate is formed on the sample S.

On the other hand, the light irradiation apparatus 2 of the measurement apparatus 1 according to the present embodiment includes the light source 11 that emits light, the light pipe 15 that receives, as an input, the light emitted from the light source 11, and uniformizes and outputs the illuminance distribution of the light, the diffusion unit 16 that diffuses the light output from the light pipe 15, and the light pipe 17 to which the light diffused by the diffusion unit 16 is input, and that uniformizes and outputs the illuminance distribution of the light. The diffusion unit 16 is the light diffusion surface 16a provided on the light output surface of the light pipe 15 That is, the light irradiation apparatus 2 includes the two light pipes 15 and 17 and the light diffusion surface 16a provided on the light output surface of the light pipe 15 at a preceding stage.

In the light irradiation apparatus 2, the illuminance distribution of the light emitted from the light source 11 is uniformized by the light pipe 15, the light output by the light pipe 15 is diffused by the diffusion unit 16, and the illuminance distribution of the light diffused by the diffusion unit 16 is uniformized by the light pipe 17. The light pipe 15 is provided, and thus, the diffusion unit 16 is irradiated with the uniformized light. In addition, the diffusion unit 16 is provided, and thus, the virtual image of the non-uniform light incident on the light pipe 15 is prevented from being incident on the light pipe 17 at the subsequent stage. Further, the light pipe 17 is provided, and thus, the diffused light from the diffusion unit 16 is uniformized. As a result, the image of the irregularities of the diffusion unit 16 is prevented from being formed on the light image of the sample S to be finally irradiated with light. From the above, in accordance with the light irradiation apparatus 2 of the measurement apparatus 1 according to the present embodiment, the light with which the sample S is irradiated can be appropriately uniformized.

FIG. 5(c) is a diagram illustrating an imaging result of the measurement apparatus 1 according to the present embodiment. As illustrated in FIG. 5(c), on the imaged image imaged by the imaging unit 26 of the measurement apparatus 1, the appearance of the virtual image is sufficiently suppressed as compared with the imaged images according to the comparative example illustrated in FIGS. 5(a) and 5(b). This is because the virtual image due to the reflection from the unexpected reflection surface is also uniformized by being separated from the large number of light sources viewed on the light input surface side by the light diffusion surface 16a of the diffusion unit 16 and a scene in which the virtual image is superimposed is not visually recognized. As described above, from the imaging result, it can also be confirmed that the light can be uniformized in the measurement apparatus 1.

Here, in the light irradiation apparatus 2, the light diffusion surface 16a is formed on at least one of the light output surface of the first light pipe and the light input surface of the second light pipe. In accordance with such a configuration in which the light diffusion surface 16a is formed on the light output surface of the light pipe 15 (or the light input surface of the light pipe 17), for example, since a loss of light corresponding to a thickness of the diffusion plate, which is a problem in a configuration in which the diffusion plate or the like is sandwiched as a separate member between the two light pipes 15 and 17, is suppressed, a decrease in intensity of light can be appropriately suppressed.

In the light irradiation apparatus 2 according to the present embodiment, the diameter of the light output surface of the light pipe 15 may be the same as the diameter of the light input surface of the light pipe 17. In addition, in the light irradiation apparatus 2 according to the present embodiment, the diameter of the light input surface of the light pipe 17 may be smaller than the diameter of the light output surface of the light pipe 15. For example, in a case where the diameter of the light output surface of the light pipe 15 is smaller than the diameter of the light input surface of the light pipe 17, since the light is input only to a part of the light input surface of the light pipe 17, there is a possibility that the light output from the light pipe 17 is not sufficiently uniformized. In particular, in a case where the diameter of the light input surface of the light pipe 17 is the same as the diameter of the light output surface of the light pipe 15, it is possible to achieve uniformity of light output from the light pipe 17 and suppression of a decrease in the amount of light.

The measurement apparatus 1 according to the present embodiment includes the light irradiation apparatus 2 described above, and the imaging unit 26 that images the emission light (measurement light) generated by the light with which the sample S is irradiated by the light irradiation apparatus 2. In accordance with such a configuration, the sample S can be irradiated with the uniformized light, and the emission light (measurement light) generated from the sample S can be imaged with high accuracy.

Although the light irradiation apparatus 2 and the measurement apparatus 1 including the light irradiation apparatus 2 according to the present embodiment have been described above, the present invention is not limited to the above embodiment.

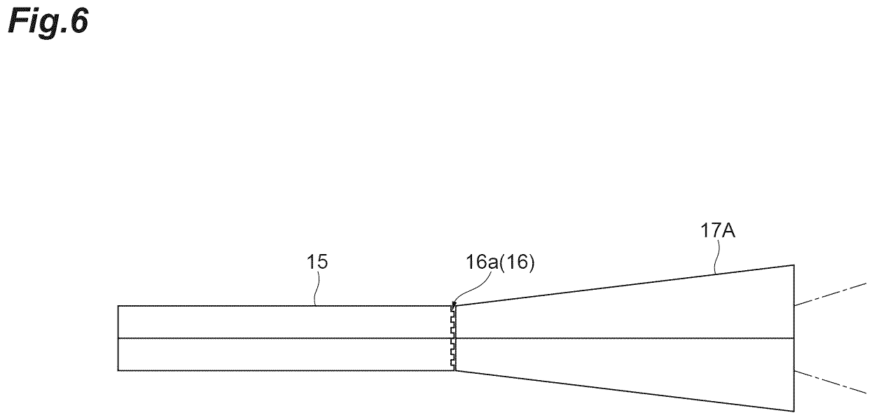

FIG. 6 is a configuration diagram of a light pipe 17A according to a modification. The light pipe 17A corresponds to the second light pipe (second uniformizing optical system). A diameter of a light output surface of the light pipe 17A is formed to be larger than a diameter of a light input surface of the light pipe 17A. More specifically, the light pipe 17A is formed in a tapered shape whose diameter increases from the light input surface side toward the light output surface side. In accordance with such a configuration, the irradiation range on the sample S can be expanded, and a wide range can be irradiated with uniform light.

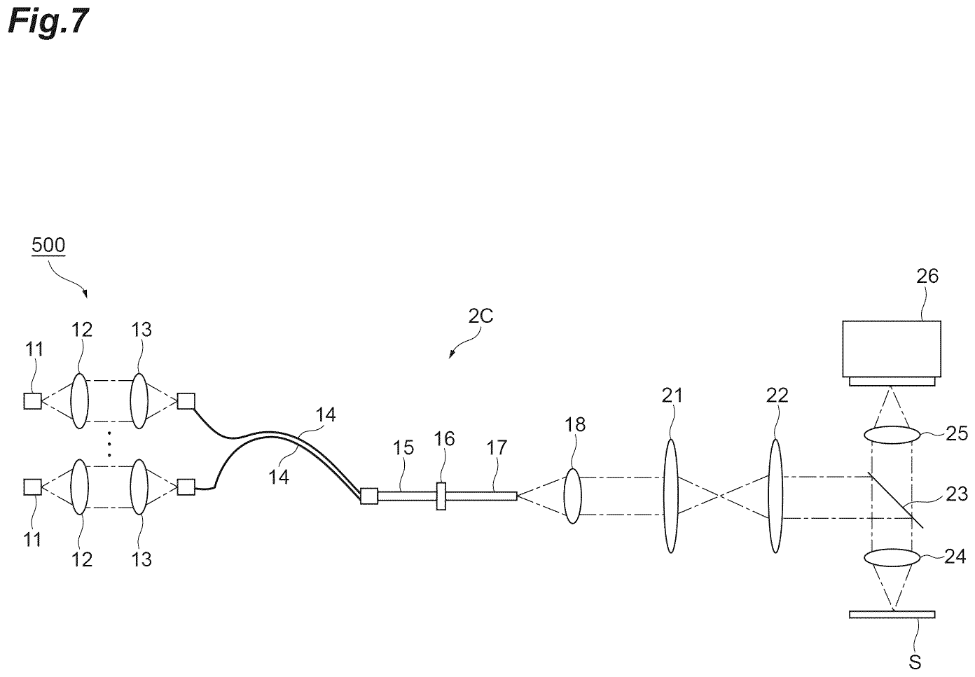

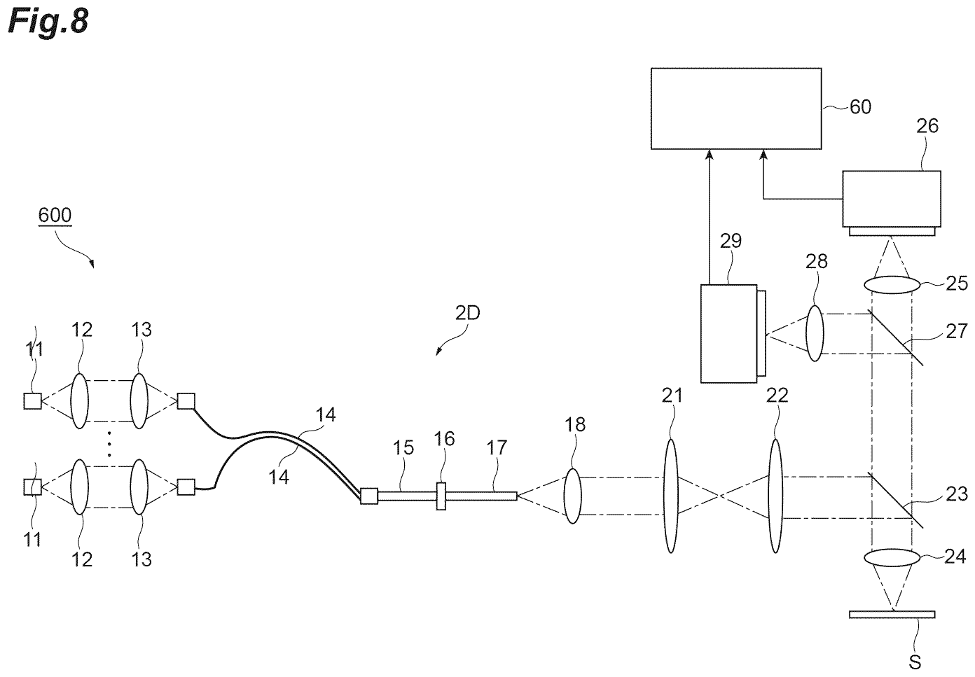

In addition, since the light irradiation apparatus according to one aspect of the present invention can realize uniform light irradiation to an area, the light irradiation apparatus may be used in an apparatus other than the measurement apparatus 1 described above. FIG. 7 is a configuration diagram of an observation apparatus 500 including a light irradiation apparatus 2C according to a modification. FIG. 8 is a configuration diagram of a film thickness measurement apparatus 600 including a light irradiation apparatus 2D according to a modification. The observation apparatus 500 illustrated in FIG. 7 irradiates a

predetermined range on the sample S with light having uniform intensity, images light reflected on the predetermined range, and observes the front surface of the sample S based on the obtained image data. As described above, in the measurement apparatus 1 described above, emission light such as fluorescence is imaged, whereas in the observation apparatus 500, reflected light in the sample S is imaged. Here, the sample S may be, for example, a portion on which surface coating is performed, such an automobile. In this case, the observation apparatus 500 may observe the surface-coated portion, for example, by imaging light reflected from the surface-coated portion. Such an observation result is used, for example, as illumination for evaluating a front surface (in particular, a surface having a multilayer structure) of a mirror surface. In addition, the observation apparatus 500 may be used for scratch inspection of the front surface.

As illustrated in FIG. 7, the observation apparatus 500 includes the light irradiation apparatus 2C and the imaging unit 26. The light irradiation apparatus 2C includes a plurality of sets of a light source 11, light guide lenses 12 and 13, and an optical fiber cable 14. The light sources 11 may output light rays of different wavelengths. In the light irradiation apparatus 2C, the sample S is irradiated with light rays of various wavelengths while changing the light source 11 that emits light. A basic configuration of the observation apparatus 500 is the same as the measurement apparatus 1 except that the plurality of sets of light sources 11 and the like are provided and the reflected light from the sample S is imaged.

In the light irradiation apparatus 2C, the sample S is irradiated with light uniformized through the light pipe 15, the diffusion unit 16, and the light pipe 17 through each optical system, and an image of the reflected light from the sample S is formed on the imaging unit 26 by the image forming lens 25. In accordance with such an observation apparatus 500, since the sample S is irradiated with the uniformized light, the reflected light (observation light) can be imaged with high accuracy, and the above-described scratch inspection and the like on the front surface can be performed with high accuracy.

The film thickness measurement apparatus 600 illustrated in FIG. 8 irradiates a predetermined range on the sample S with light having uniform intensity, images light multiple-reflected on the predetermined range, and obtains a film thickness distribution of the range based on obtained image data. The sample S in this case may be, for example, a light emitting element such as an LED, a mini LED, a μLED, an SLD element, a laser element, a vertical laser element (VCSEL), or an OLED, or may be a light emitting element that adjusts a light emission wavelength by a fluorescent substance including a nano dot or the like.

The film thickness measurement apparatus 600 includes the light irradiation apparatus 2D, imaging units 26 and 29, and an analysis unit 60 (film thickness derivation unit). The light irradiation apparatus 2D includes a dichroic mirror 27 and an image forming lens 28 in addition to the configuration of the light irradiation apparatus 2C described above.

In the film thickness measurement apparatus 600, the sample S is irradiated with the light uniformized through the light pipe 15, the diffusion unit 16, and the light pipe 17 through each optical system, and the reflected light from the sample S reaches the dichroic mirror 27 via the half mirror 23.

The dichroic mirror 27 is a mirror created by using a special optical material, and is an optical element that divides light multiple-reflected on the sample S by transmitting and reflecting the light according to a wavelength. The dichroic mirror 27 may be configured such that transmittance and reflectance of light change according to a wavelength in a predetermined wavelength region. That is, in the dichroic mirror 27, the transmittance (and reflectance) of the light gently changes according to a change in wavelength in the predetermined wavelength region, and the transmittance (and reflectance) of the light is constant regardless of a change in wavelength in a wavelength region other than the predetermined wavelength region. The light output from the light source 11 includes light of a wavelength included in a predetermined wavelength region of the dichroic mirror 27.

The image forming lens 25 forms an image of the reflected light having passed through the dichroic mirror 27 and having reached from the sample S, and guides the reflected light to the imaging unit 26. The image forming lens 28 forms an image of the reflected light reflected by the dichroic mirror 27 and having reached from the sample S, and guides the reflected light to the imaging unit 29. The imaging unit 26 is a camera that images the reflected light from the sample S imaged by the image forming lens 25. The imaging unit 29 is a camera that images the reflected light from the sample S imaged by the image forming lens 28. Imaging data by the imaging units 26 and 29 is output to the analysis unit 60. As described above, the imaging units 26 and 29 image the observation light, which is the light with which the sample S is irradiated from the light irradiation apparatus 2D, and output the imaging data.

The analysis unit 60 is a computer, and physically includes a memory such as a RAM and a ROM, a processor (arithmetic circuit) such as a CPU, a communication interface, and a storage unit such as a hard disk. The analysis unit 60 functions by executing a program stored in the memory by the CPU of the computer system. The analysis unit 60 may include a microcomputer or an FPGA.

The analysis unit 60 derives a film thickness of the sample S based on signals (imaging data) from the imaging units 26 and 29 having imaged light. The analysis unit 60 estimates a film thickness corresponding to each pixel based on wavelength information for each pixel in the imaging units 26 and 29. More specifically, for example, the analysis unit 60 may derive a wavelength center of gravity of light for each pixel based on the amount of transmitted light specified based on the imaging data in the imaging unit 26, the amount of reflected light specified based on the imaging data in the imaging unit 29, a center wavelength of the dichroic mirror 27 (a center wavelength in a predetermined wavelength region), and a width of the dichroic mirror 27, and may estimate a film thickness corresponding to each pixel based on the wavelength center of gravity. The width of the dichroic mirror 27 is, for example, a wavelength width from a wavelength at which transmittance becomes 0% to a wavelength at which transmittance becomes 100% in the dichroic mirror 27.

Specifically, the analysis unit 60 derives the wavelength center of gravity of each pixel based on the following Expression (1). In the following Expression (1), λ represents a wavelength center of gravity, λ0 represents a center wavelength of the dichroic mirror 27, A represents a width of the dichroic mirror 27, R represents the amount of reflected light, and T represents the amount of transmitted light.

$$λ = λ 0 + A ( T - R ) / 2 ( T + R ) \qquad ( 1 )$$

In a case where λ (the wavelength center of gravity) is derived by the above Expression (1), λ=λ0 (the center wavelength of the dichroic mirror 27) is assumed for a pixel in which T (the amount of transmitted light)=R (the amount of reflected light). In addition, for a pixel in which T<R, that is, a pixel in which the amount of reflected light is larger than the amount of transmitted light, λ=λ1 (a wavelength on a shorter wavelength side than 20) is set. In addition, for a pixel in which T>R, that is, a pixel in which the amount of transmitted light is larger than the amount of reflected light, Δ=λ2 (a wavelength on a longer wavelength side than λ0) is set. As described above, a value of λ (the wavelength center of gravity) is shifted (wavelength shift) based on the amount of transmitted light and the amount of reflected light.

Note that, the method of deriving the wavelength center of gravity is not limited to the above method. For example, since λ (the wavelength center of gravity) has a proportional relationship with the following x, the wavelength center of gravity may be derived from the following Expressions (2) and (3). In the following Expression (3), IT represents the amount of transmitted light, and IR represents the amount of reflected light. In addition, in a case where a spectrum shape to be measured or a line formation of the dichroic mirror 27 is an ideal shape, parameters a and b in Expression (2) can be determined by optical characteristics of the dichroic mirror 27.

$$λ = ax + b \qquad ( 2 )$$

$$x = ( IT - IR ) / 2 ( IT + IR ) \qquad ( 3 )$$

Note that, since there is actually a difference (individual difference) in spectral characteristics between the optical system and the camera, for the purpose of correcting the difference, for example, x may be derived by the following Expression (4) by using the signal intensity of the substrate having a known reflection characteristic as a reference. In the following Expression (4), ITr represents the amount of transmitted light in the reference, and IRr represents the amount of reflected light in the reference.

$$x = ( IT / ITr - IR / IRr ) / 2 ( IT / ITr + IR / IRr ) \qquad ( 4 )$$

In addition, for the purpose of removing the influence of direct light from the light source, x may be derived by the following Expression (5) by using a signal amount in a non-reflection state. In the following Expression (5), ITb represents the amount of transmitted light in the non-reflection state, and IRb represents the amount of reflected light in the non-reflection state.

$$x = \{ ( IT - ITb ) / ( ITr - ITb ) - ( IR - IRb ) / ( IRr - IRb ) \} / 2 \{ ( IT - ITb ) / ( ITr - ITb ) + ( IR - IRb ) / ( IRr - IRb ) \} \qquad ( 5 )$$

In addition, in order to comprehensively perform various corrections such as film characteristics, an irradiation spectrum, and nonlinearity of the dichroic mirror 27, the wavelength center of gravity (λ) may be approximated by a polynomial equation such as the following Expression (6). Note that, each parameter (a, b, c, d, and e) in the following Expression (6) is determined, for example, by measuring a plurality of samples having different wavelength centers of gravity (film thicknesses).

$$λ = ax 4 + bx 3 + cx 2 + dx + e \qquad ( 6 )$$

A relationship between the wavelength and the film thickness can be described by the following Expression (7). In the following Expression (7), n represents a refractive index of the film, d represents a film thickness, m represents a positive integer (1, 2, 3, . . . ), and λ represents a wavelength center of gravity. 2nd indicates an optical path difference (an optical path difference caused by the arrangement of the film). The analysis unit 60 estimates the film thickness corresponding to each pixel from the wavelength center of gravity of each pixel based on the following Expression (7).

$$\begin{matrix}2 nd = m λ ( m = 1 , 2 , 3 , … ) ( mutually reinforcing condition ) \\ 2 nd = ( m - 1 / 2 ) λ ( m = 1 , 2 , 3 , … ) ( mutually weakening condition )\end{matrix} \qquad ( 7 )$$

Here, Expression (7) indicating the relationship between the wavelength and the film thickness described above is established in a case where light is perpendicularly incident on the sample S. On the other hand, in a case where the light is not perpendicularly incident on the sample S, the above Expression (7) is not established. Thus, in order to estimate the film thickness with high accuracy at any measurement point (incident angle), calculation (correction processing) corresponding to the measurement point (incident angle) is required.

In a case where the incident angle of the light is 0, the optical path difference is indicated by 2nd cos θ. As a result, the relationship between the wavelength and the film thickness in consideration of the incident angle θ can be described by the following Expression (8). The analysis unit 60 estimates the film thickness corresponding to the measurement point (incident angle) based on the following Expression (8). As described above, the analysis unit 60 may estimate the film thickness from the wavelength center of gravity in further consideration of an angle of the light with which the sample S is irradiated.

$$\begin{matrix}2 nd cos θ = m λ ( mutually reinforcing condition ) \\ 2 nd cos θ = ( m - 1 / 2 ) λ ( mutually weakening condition )\end{matrix} \qquad ( 8 )$$

In accordance with such a film thickness measurement apparatus 600, the sample S can be irradiated with the uniformized light, and the film thickness of the sample S can be derived with high accuracy.

### REFERENCE SIGNS LIST

1 measurement apparatus
2, 2C, 2D light irradiation apparatus
11 light source
15 light pipe (first uniformizing optical system or first light pipe)
16 diffusion unit
17, 17A light pipe (second uniformizing optical system or second light pipe)
26, 29 imaging unit
60 analysis unit (film thickness derivation unit)
500 observation apparatus
600 film thickness measurement apparatus
S sample (measurement target)

1. A light irradiation apparatus comprising:
a light source configured to emit light;
a first light pipe configured to receive, as an input, the light emitted from the light source, and uniformize and output an illuminance distribution of the light;
a diffusion unit configured to diffuse the light output from the first light pipe; and
a second light pipe configured to receive, as an input, the light diffused by the diffusion unit, and uniformize and output an illuminance distribution of the light, wherein
the diffusion unit is a light diffusion surface provided on at least one of a light output surface of the first light pipe and a light input surface of the second light pipe.

2. The light irradiation apparatus according to claim 1, wherein a diameter of the light incident surface of the second light pipe is the same as a diameter of the light output surface of the first light pipe.

3. The light irradiation apparatus according to claim 1, wherein a diameter of the light input surface of the second light pipe is smaller than a diameter of the light output surface of the first light pipe.

4. The light irradiation apparatus according to claim 1, wherein a diameter of a light output surface of the second light pipe is larger than a diameter of the light input surface of the second light pipe.

5. The light irradiation apparatus according to claim 1, wherein the light diffusion surface is a translucent surface.

6. A measurement apparatus comprising:
the light irradiation apparatus according to claim 1; and
an imager configured to image measurement light generated by light with which a measurement target is irradiated from the light irradiation apparatus.

7. An observation apparatus comprising:
the light irradiation apparatus according to claim 1; and
an imager configured to image observation light that is light with which a measurement target is irradiated from the light irradiation apparatus.

8. A film thickness measurement apparatus comprising:
the light irradiation apparatus according to claim 1;
an imager configured to image observation light that is light with which a measurement target is irradiated from the light irradiation apparatus, and output imaging data; and
a film thickness derivation unit configured to derive a film thickness of the measurement target based on the imaging data.
